(19) United States
(12) Patent Application Publication
(10) Pub. No.: US 2023/0066172 A1
(43) Pub. Date: Mar. 2, 2023

(54) Aerosol Generation Device with Ceramic Heater Base

(71) Applicant: JT International SA, Genève (CH)

(72) Inventor: Peter Loveday, Epsom Surrey (GB)

(73) Assignee: JT International SA, Genève (CH)

(21) Appl. No.: 17/800,335

(22) PCT Filed: Feb. 17, 2021
(86) PCT No.: PCT/EP2021/053899

§ 371 Date: Aug. 17, 2022

(30) Foreign Application Priority Data
Feb. 18, 2020 (EP) 20158052.9

(51) Int. Cl. A24F 40/46; A24F 40/20; A24F 40/51

(52) U.S. Cl. CPC A24F 40/46; A24F 40/20; A24F 40/51; H05B 3/46

(57) ABSTRACT

The present invention relates to an aerosol generation device. In particular, the invention relates to an aerosol generation device with heating elements provided between a ceramic heater base and a heating chamber. An aerosol generation device comprises a heating chamber for heating and receiving at least part of a consumable, a ceramic heater base, and one or more heating elements arranged between the ceramic heater base and the heating chamber and configured to heat at least parts of the heating chamber.

### TECHNICAL FIELD OF THE INVENTION

The present invention relates to an aerosol generation device. In particular, the invention relates to an aerosol generation device with heating elements provided between a ceramic heater base and a heating chamber.

### BACKGROUND OF THE INVENTION

Aerosol generation devices are used with consumables with a wide range of aerosol generating substrates comprising liquids and tobacco substrates. For certain substrates, the temperature to which they are heated should be well-controlled, evenly distributed for the substrate and within a certain temperature range to prevent degradation of the substrate or the increased release of harmful substances for a user.

Aerosol generation devices oftentimes employ heating elements arranged upstream of the aerosol generating substrate with regard to the airflow direction, the result being that the heating efficiency is low and the aerosol generating substrate is unevenly heated.

Other devices have a heating chamber, around which a heating film or tape (sheet heater) is wrapped. They are typically used with consumables or smoking articles in the form of tobacco sticks. However, they have the disadvantage that the temperature is applied irregularly and/or in a diffusive manner. In addition, the proper placement of a temperature sensor can be problematic and may cause temperature control inaccuracy and with time lags, which may result in power overshooting. Furthermore, in devices with air gaps between the sheet heater and the heating chamber walls, the aerosol generating substrate is unevenly and inefficiently heated.

Therefore, there is a need for an aerosol generation device that offers an efficient heating of the aerosol generating substrate and a regular, quick, accurate and responsive control of the temperature of an aerosol generating substrate. There is also a need for an aerosol generation device that offers improved insulation efficiency.

### SUMMARY OF THE INVENTION

The present invention provides an aerosol generation device with a ceramic heater base, which solves some or all of the above problems.

A first aspect of the invention is an aerosol generation device comprising a heating chamber for heating and receiving at least part of a consumable, a ceramic heater base, and one or more heating elements arranged between the ceramic heater base and the heating chamber and configured to heat at least parts of the heating chamber. The ceramic base affords a more efficient distribution of heat, in particular, in areas where heat is preferably required and avoids unintentional voids between heater and heating chamber due to imperfect wrapping of the films. Additionally, it may serve as a support for the heating elements and/or a temperature sensor to be arranged between the ceramic heater base and the heating chamber. The positioning of these elements is consequently more precise leading to a more efficient operation of the device.

According to a second aspect, in the preceding aspect, the heating chamber comprises on its interior surface one or more interior chamber protrusions for compressing at least parts of the part of the consumable received by the heating chamber. This ensures thermal contact between the heating chamber and the consumable while managing airflow between the consumable and the heating chamber thereby improving the heating performance. Furthermore, compressing the substrate mechanically secures the substrate to the aerosol generation device to prevent the substrate from accidentally being removed.

According to a third aspect, in the preceding aspect, the heating chamber comprises on its exterior surface one or more exterior chamber indentations corresponding to the one or more interior chamber protrusions. Therefore, the thickness of the chamber at the location of the protrusions can be kept minimal thereby providing efficient heat transfer. Providing the interior chamber protrusions may be achieved by cost-efficient stamping or pressing methods, thus reducing manufacturing costs, and resulting in exterior chamber indentations of the one or more exterior chamber protrusions that correspond to interior chamber protrusions of the one or more interior chamber protrusions.

According to a fourth aspect, in the preceding aspect, the ceramic heater base comprises on its interior surface one or more interior base protrusions. Having such protrusions enables to focus heat in areas of the heating chamber where it is required and enables to reduce heat losses and overall to improve electrical power efficiency.

According to a fifth aspect, in the preceding aspect, the one or more interior base protrusions correspond to one or more exterior chamber indentations. Thus, the base protrusions may advantageously reduce or remove air gaps between the ceramic heater base and the heating chamber wall created by the indentations. The heat can therefore be predominantly directed to the compressed areas of the aerosol generating substrate where heat is the most desired.

According to a sixth aspect, in any one of the fourth or fifth aspect, one or more or preferably all of the one or more heating elements are arranged in exterior chamber indentations. This increases the heating performance of the aerosol generating device and therefore increases battery life. It also reduces the time lag between applying average voltage to the heating elements and the registration by a temperature sensor. It therefore affords a more accurate and responsive control of the temperature of the heating chamber and avoids overshooting.

According to a seventh aspect, in the preceding aspect, one or more heating elements arranged in exterior chamber indentations substantially abut the respective exterior chamber indentations so that there is no gap therebetween. Removing air gaps between heating elements and respective exterior chamber indentations further improves the heating performance and increases the responsiveness of the temperature control of the heating chamber.

According to an eighth aspect, in any one of the sixth or seventh aspect, one or more or preferably all of the one or more heating elements are provided on interior base protrusions of the ceramic heater base. Removing air gaps between heating elements and respective interior base protrusions further improves the heating performance and affords a more even heat distribution by the ceramic base.

According to a ninth aspect, in any one of the preceding aspects, at least one temperature sensor is provided between the heating chamber and the ceramic heater base, preferably in the proximity of one of the one or more heating elements. This allows a more accurate and faster determination of the temperature of the heating chamber and therefore affords a more responsive and accurate temperature control.

According to a tenth aspect, in the preceding aspect and the eighth aspect, the at least one temperature sensor is provided on one of the one or more interior base protrusion that are provided with one or more heating elements.

According to an eleventh aspect, in any one of the preceding aspects, the one or more heating elements comprise metal heating elements that are printed on a surface of the ceramic heater base or embedded in a sintered ceramic material of the ceramic heater base. Printing or sintering heating elements directly onto the ceramic heater base is cost-efficient and provides heating elements with reduced thickness.

According to a twelfth aspect, in any one of the preceding aspects, the ceramic heater base comprises a plurality of ceramic heater base elements, preferably two ceramic heater base elements, that divide the ceramic heater base in a circumferential direction of the heating chamber and along the longitudinal direction corresponding to the insertion/removal direction of the consumable into/from the aerosol generation device.

This reduces the manufacturing complexity, in particular as the heating chamber is provided with exterior chamber indentations and the ceramic heater base is provided with corresponding interior base protrusions, as the plurality of ceramic heater base elements may simply be fitted on the exterior of the heating chamber.

According to a thirteenth aspect, in the preceding aspect, the ceramic heater base element has a maximum thickness of 0.5 to 1.5 mm, 0.5 to 1.5 mm, preferably of 0.75 to 1.25, more preferably of 0.9 to 1.1 mm, most preferably of 1 mm, to allow adequate structural strength. A gap extending in the longitudinal direction may also be provided between each ceramic heater base element. The gap provides the adequate tolerance for assembling and is preferably kept minimal, e.g. 0.2-1 mm, to reduce heat loss.

According to a fourteenth aspect, in any one of the preceding aspects,

the ceramic heater base has a polygonal cross-section. A polygonal cross-section reduces contact points with an aerosol generation device exterior housing that commonly exhibits a circular cross-section, thus increasing the thermal insulation to an exterior of the aerosol generation device and increasing the heating performance of the one or more heating elements.

According to a fifteenth aspect, in any one of the preceding aspects, the ceramic heater base extends at least partially along the length of the heating chamber in the longitudinal direction and is provided circumferentially around the heating chamber. By providing the ceramic base at least partially around the exterior of the heating chamber, a more even heat distribution can be achieved and the heating performance of the one or more heating elements can be improved.

According to a sixteenth aspect, in any one of the preceding aspects, the ceramic heater base comprises a porous ceramic material. The base can thus provide heat insulation outside the zones where the heating elements extend. The thickness of the porous ceramic material may be determined to optimize or complement heat insulation properties of the device where needed.

According to a seventeenth aspect, in any one of the preceding aspects, an insulating member is provided between the ceramic heater base and an outside of the aerosol generation device and at least partially envelops the heating chamber and the ceramic heater base. The insulating member improves the thermal insulation of the ceramic heater base and the heating chamber, thus improving the heating performance of the one or more heating elements and providing a more even heat distribution.

According to an eighteenth aspect, in the preceding aspect, the insulating member comprises an aerogel layer, vacuum layer or tube and/or heat reflective metal coating. These materials and/or components offer good thermal insulation characteristics, in particular in the confined space of the aerosol generation device.

### BRIEF DESCRIPTION OF THE DRAWINGS

FIG. 1 shows an illustrated exploded view of a portion of an aerosol generation device according to embodiments of the invention;

FIGS. 2A and 2B show an illustrated cross-sectional view and an illustrated top view, respectively, of an aerosol generation device according to embodiments of the invention;

FIG. 3A shows a perspective view of a ceramic heater base according to embodiments of the invention;

FIG. 3B shows an illustrated perspective view of an interior side of a portion of the ceramic heater base shown in FIG. 3A.

### DETAILED DESCRIPTION OF PREFERRED EMBODIMENTS

Preferred embodiments of the present invention are described hereinafter and in conjunction with the accompanying drawings.

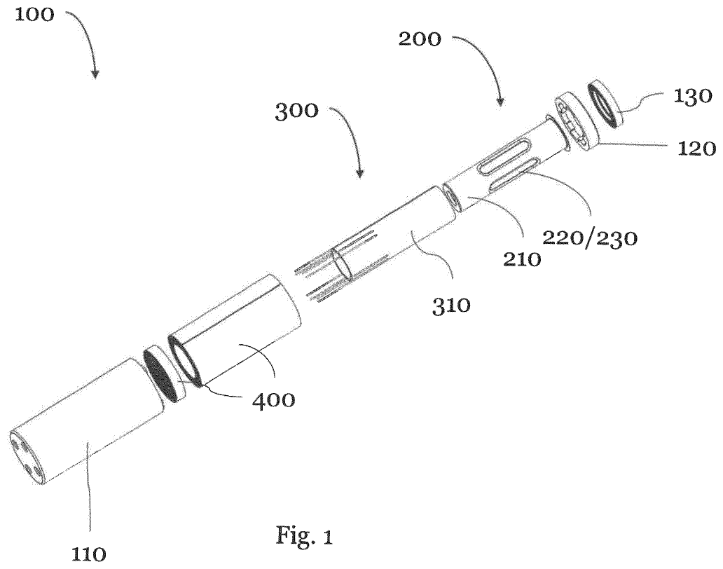

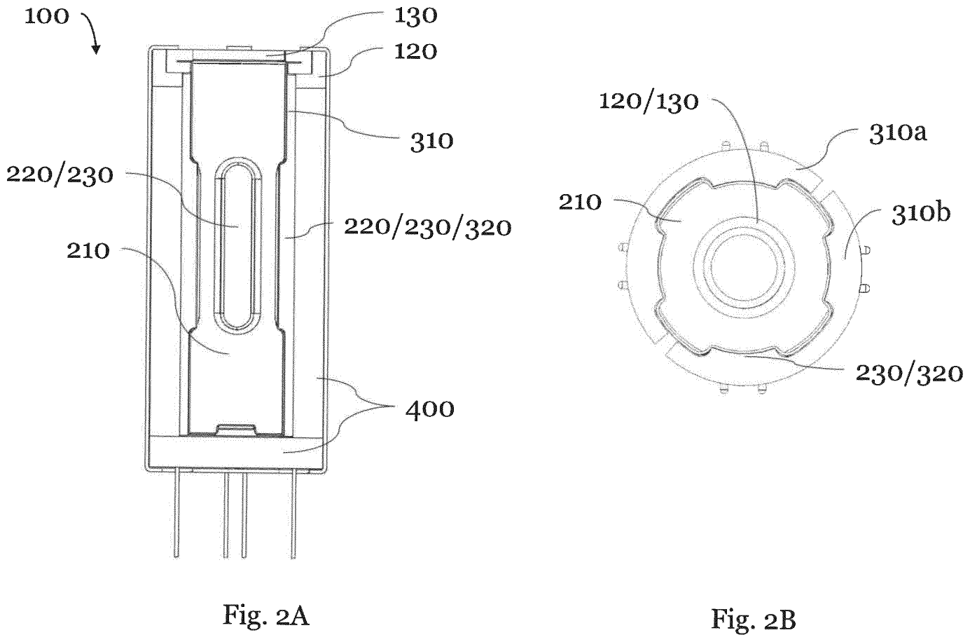

As shown in FIG. 1, FIG. 2A and FIG. 2B, an aerosol generation device comprises a heating chamber 200 that comprises a heating chamber wall 210 that may be provided with one or more interior chamber protrusions 220 that may extend in axial direction of the chamber for squeezing an aerosol generating substrate, in particular a tubular tobacco stick, that is at least partially inserted into the heating chamber 200. The chamber protrusions enable to manage airflow between the substrate and the chamber outside the protrusions. The heating chamber 200 may further be provided with one or more exterior chamber indentations 230. Some or preferably all of the indentations may correspond to protrusions of the one or more interior chamber protrusions 220.

As a result, the heat transfer through the wall of the chamber is not significantly hindered by the thickness of the protrusion. Heating elements 330 may be provided in such indentations. Hence, the heat can advantageously be focused in the area of the protrusions. Additionally, or alternatively, the heating elements may be provided on the ceramic heater base 300. Hence, the precise positioning of the heating elements can be guaranteed. The ceramic heater base 300 may extend at least partially along the length of the heating chamber 200 and may further be provided circumferentially around the heating chamber 200. The ceramic heater base 300 may be provided with one or more interior base protrusions 320. The number of interior base protrusions 320 may match the number of exterior chamber indentations, and the one or more base protrusions 320 preferably correspond to indentations 230 of the heating chamber 200. The heating elements 330 may be provided on protrusions of the one or more interior base protrusions 320. Hence, the heat is also advantageously focused in the area of the protrusions and heat transfer is improved as a perfect fit between of the protrusions and indentations can be obtained removing undesired air pockets or voids. Additionally, they may be provided in exterior chamber indentations 230 and/or on interior base protrusions 320. The heating elements 330 may be configured and arranged such that the heating elements abut indentations of the exterior chamber indentations 230 to ensure an optimal thermal contact to the heating chamber 200. The ceramic heater base 300 may consist of or comprise a porous ceramic material. Hence, the ceramic heater further provides heat insulation properties to reduce heat loss outwardly. The aerosol generation device may further be provided with an insulating member between the ceramic heater base 300 and an exterior or housing of the aerosol generation device 100, which preferably at least partially envelops the ceramic heater base 300 and the heating chamber 200 to provide a thermal insulation. The insulating member 400 may comprise any one of an aerogel layer, a vacuum layer or tube, a heat reflective metal coating and/or any combination thereof. For example, the insulating member 400 may comprise an annular element and an end disc-shaped element covering the bottom of the heating chamber 200. The aerosol generation device 100 may further be provided with a spacer element 120 and a connection element 130 that form a connection between the casing 11o and the heating chamber with the insulation 400 in-between. The connection element 130 may hold the upper flange of the heating chamber 200. The spacer ensures that the heating chamber does not directly contact the outer casing 11o such that the surface of the casing remains preferably below 50° C. The spacer and connection element 130 can be made of a heat resistant and rigid material such as PEEK.

As shown in FIG. 2B, the ceramic heater base 300 may comprise a first ceramic heater base element 310a and a second ceramic heater base element 310b. The ceramic heater base 300 may in general comprise any suitable number of ceramic heater base elements of the same or different sizes. The first element 310a and the second element 310b may be separate from each other along the direction of the length of the heating chamber and may be separated by a gap.

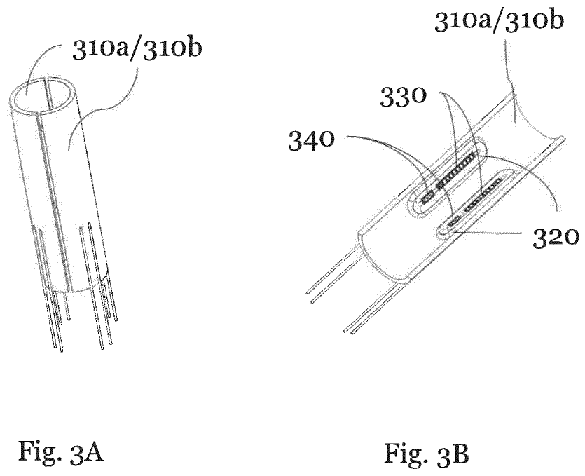

FIG. 3A illustrates a ceramic heater base 300 of an aerosol generation device 100 as described in the context of FIGS. 1, 2A and 2B. While the ceramic heater base 300 is shown to comprise two ceramic heater base elements 310a and 310b of the same size, that are separate from each other along the direction of the length of the ceramic heater base 300, the ceramic heater base 300 may comprise any suitable number of ceramic heater base elements of different sizes and/or the same size. FIG. 3B illustrates an interior side of one ceramic heater base element 310a and/or 310b. The base element 310a/310b is provided two interior base protrusions 320 on its interior surface. While the protrusions 320 are shown to be of the same size and shape and to be positioned at the same position along the length of the base element 310a/310b, the protrusions 320 may be of any suitable size and shape. Also, they may be the same or different, and be provided at different positions along the length of the base element 310a/310b. A heating element 330 is preferably provided on each protrusion 320. Alternatively, one and/or both protrusions may be provided with more than one or with no heating element 330. The heating elements 330 may be provided on the protrusions 320 by means of sintering and/or printing onto the protrusions 320. The heating elements may preferably be resistive heaters. They may be printed on the ceramic surface.

Alternatively, the heating element can be a heater track embedded in the ceramic material of the ceramic heater base during the ceramic sintering process. An electrically insulating layer may need to be applied to the inner surface of the ceramic base or the outer surface of the heating chamber. Alternatively, the heating elements 330 may be film heaters, which are typically thin. Additionally, a temperature sensor 340 may be provided on one or both of the interior protrusions 320 of the base element 310a/310b, preferably in close proximity to the heating element 330 on the protrusions 320, to ensure a more accurate and faster determination of the temperature of the heating elements and/or the heater base 300 and/or the heating chamber 200 at which the heater base is provided. The temperature sensor may be a thermistor such as NTC, a resistance thermometer (RTD), thermocouple or semi-conductor-based sensor. The skilled person appreciates that while the ceramic heater base 300 is shown to include two heater base elements 310a and 310b, the ceramic heater base may comprise any suitable number of base elements, and each base element may be configured as described above.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the scope of this disclosure, as defined by the independent and dependent claims.

### LIST OF REFERENCE SIGNS USED IN THE DRAWINGS

100: aerosol generation device
110: device casing
120: spacer element
130: connection element
200: heating chamber
210: heating chamber wall
220: interior chamber protrusions
230: exterior chamber indentations
300: ceramic heater base
310/310a/310b: ceramic heater base elements
320: interior base protrusions
330: heating element
340: temperature sensor
400: insulating member

1. An aerosol generation device comprising:
a heating chamber for heating and receiving at least part of a consumable;
a ceramic heater base; and
one or more heating elements arranged between the ceramic heater base and the heating chamber and configured to heat at least parts of the heating chamber.

2. The aerosol generation device according to claim 1,
wherein an interior surface of the heating chamber comprises one or more interior chamber protrusions for compressing at least part of the consumable received by the heating chamber.

3. The aerosol generation device according to claim 2,
wherein an exterior surface of the heating chamber comprises one or more exterior chamber indentations corresponding to the one or more interior chamber protrusions.

4. The aerosol generation device according to claim 3,
wherein an interior surface of the ceramic heater base comprises one or more interior base protrusions.

5. The aerosol generation device according to claim 4,
wherein the one or more interior base protrusions correspond to the one or more exterior chamber indentations.

6. The aerosol generation device according to claim 4,
wherein one or more of the one or more heating elements are arranged in the one or more exterior chamber indentations.

7. The aerosol generation device according to claim 6,
wherein the one or more heating elements arranged in the exterior chamber indentations substantially abut respective exterior chamber indentations so that there is no gap therebetween.

8. The aerosol generation device according to claim 6, wherein
the one or more of the one or more heating elements are provided on the interior base protrusions of the ceramic heater base.

9. The aerosol generation device according to claim 8,
wherein at least one temperature sensor is provided between the heating chamber and the ceramic heater base.

10. The aerosol generation device according to claim 9,
wherein the at least one temperature sensor is provided on one of the one or more interior base protrusions that are provided with one or more heating elements.

11. The aerosol generation device according to claim 1,
wherein the one or more heating elements comprise metal heating elements that are printed on a surface of the ceramic heater base or embedded in a sintered ceramic material of the ceramic heater base.

12. The aerosol generation device according to claim 1,
wherein the ceramic heater base comprises at least two ceramic heater base elements that divide the ceramic heater base in a circumferential direction of the heating chamber and along a longitudinal direction corresponding to an insertion/removal direction of the consumable into/from the aerosol generation device.

13. The aerosol generation device according to claim 1, wherein the ceramic heater base elements have a maximum thickness of 0.5 to 1.5 mm.

14. The aerosol generation device according to claim 1,
wherein the ceramic heater base has a polygonal cross-section.

15. The aerosol generation device according to claim 1,
wherein the ceramic heater base extends at least partially along a length of the heating chamber in a longitudinal direction and is provided circumferentially around the heating chamber.

16. The aerosol generation device according to claim 1, wherein the ceramic heater base comprises a porous ceramic material.

17. The aerosol generation device according to claim 1,
wherein an insulating member is provided between the ceramic heater base and an outside of the aerosol generation device and at least partially envelops the heating chamber and the ceramic heater base.

18. The aerosol generation device according to claim 17,
wherein the insulating member comprises an aerogel layer, a vacuum layer or a tube and/or a heat reflective metal coating.
